(19) United States
(12) Patent Application Publication
(10) Pub. No.: US 2024/0013244 A1
(43) Pub. Date: Jan. 11, 2024

(54) Live Local Services Results

(71) Applicant: Google LLC, Mountain View, CA (US)

(72) Inventors: Surath Sundram, Santa Clara, CA (US); Rupika Chatterjee, Santa Clara, CA (US)

(21) Appl. No.: 17/802,374

(22) PCT Filed: Dec. 2, 2021
(86) PCT No.: PCT/US2021/061624

§ 371 Date: Aug. 25, 2022

(51) Int. Cl. G06Q 30/0204; G06Q 30/0282

(52) U.S. Cl. CPC G06Q 30/0205; G06Q 30/0282

(57) ABSTRACT

The technology generally relates to identifying, in response to a search request, service providers currently available and able to perform the requested service. The identified service providers may be output as part of a list or identified on a map in response to the search request. The service providers may be ranked based on one or more factors, such as their availability at the time of the search request, a distance from the service provider's business location to the work location, a distance from a current location of the service provider to the work location, feedback pertaining to the service provider, etc. Each factor may be weighted such that one factor may influence the rank of the service provider more than another. Based on the weights, each service provider may be scored. Service providers with a higher score may be prioritized in the search results.

### BACKGROUND

Users may search for a service provider to perform work at a given location. The search results may include information pertaining to the service provider, such as their business name, address, phone number, and business hours. The results may also provide an indication as to whether the service provider is open, opening soon, closed, or closing soon. However, to determine whether the service provider is available to perform the work immediately, the user may have to call a service provider. If the service provider is unavailable, the user may have to call other service providers until they find one that is available. This is a time consuming and inconvenient process.

### BRIEF SUMMARY

The technology generally relates to identifying service providers in response to a search request that are currently available and able to perform the requested service at the time of the search request. The identified service providers may be ranked based on one or more factors, such as their availability at the time of the search request, a distance from the service provider's business location to the work location, a distance from a current location of the service provider to the work location, feedback pertaining to the service provider, etc. Each factor may be weighted such that one factor may influence the rank of the service provider more than another. Based on the weights, each service provider may be scored. Service providers with a higher score may be prioritized in the search results. The service providers may be output as part of a list or identified on a map in response to the search request.

An aspect of the disclosure includes a method comprising receiving, by one or more processors, a search query for a service at a service location, determining, by the one or more processors, one or more service providers that are available based on the search query, determining, by the one or more processors and based on the identified one or more service providers, at least one of (i) a distance between a business location of each of the one or more service providers and the service location or (ii) a distance between a current location of each of the one or more service providers and the service location, ranking, by the one or more processors based on the availability of the service provider and at least one of the determined distances, each of the one or more service providers, and providing, by the one or more processors, the ranked service providers.

Determining the one or more service providers that are available based on the search query may further include identifying, by the one or more processors, the one or more service providers within a search radius. The search radius may be a predetermined distance from the location.

Ranking each of the one or more service providers may further be based on user feedback. User feedback may include a rating of one or more of quality of work, timeliness to respond to a user request, cost of work, length of time to arrive, and preparedness to complete a job.

The method may further include receiving, by the one or more processors, an indication of availability from each of the one or more service providers, wherein the indication of availability indicates that the service provider is currently available or unavailable. Providing the ranked service providers may further include providing a list of the ranked service providers in ranked order or a map indicating a location and a rank of each ranked service provider.

The respective availabilities of each of the one or more service providers may comprise an availability score indicating a likelihood of the service provider being available to perform the service.

The method may further include determining a distance score based on the at least one of (i) the distance between a business location of each of the one or more service providers and the service location or (ii) the distance between a current location of each of the one or more service providers and the service location, wherein the ranking each of the one or more service providers is based on the distance score. The distance score may be based on which is shorter out one of (i) the distance between a business location of each of the one or more service providers and the service location or (ii) the distance between a current location of each of the one or more service providers and the service location.

Another aspect of the disclosure includes a device comprising a memory and one or more processors in communication with the memory. The one or more processors may be configured to receive a search query for a service at a service location, determine one or more service providers that are available based on the search query, determine, based on the identified one or more service providers, at least one of (i) a distance between a business location of each of the one or more service providers and the service location or (ii) a distance between a current location of each of the one or more service providers and the service location, rank, based on the availability of the service provider and at least one of the determined distances, each of the one or more service providers, and provide the ranked service provider.

Yet another aspect of the disclosure includes a non-transitory computer-readable medium storing instructions, which when executed by one or more processors, cause the one or more processors to receive a search query for a service at a service location, determine one or more service providers that are available based on the search query, determine, based on the identified one or more service providers, at least one of (i) a distance between a business location of each of the one or more service providers and the service location or (ii) a distance between a current location of each of the one or more service providers and the service location, rank, based on the availability of the service provider and at least one of the determined distances, each of the one or more service providers, and provide the ranked service providers.

### BRIEF DESCRIPTION OF THE DRAWINGS

FIG. 1 is a functional diagram illustrating an system according to aspects of the disclosure.

FIG. 2 is a pictorial diagram of an example user interface according to aspects of the disclosure.

FIG. 3 is a pictorial diagram of another example user interface according to aspects of the disclosure.

FIG. 4 is a pictorial diagram of another example user interface according to aspects of the disclosure.

FIG. 5 is a pictorial diagram of another example user interface according to aspects of the disclosure.

FIGS. 6A-6E are pictorial diagrams of example user interfaces according to aspects of the disclosure.

FIG. 7 is a pictorial diagram of another example user interface according to aspects of the disclosure.

FIG. 8 is a flow diagram illustrating a method of identifying service providers that are able and available to perform the work at the time a search query was performed.

Like reference numerals refer to corresponding parts throughout the several views of the drawings.

### DETAILED DESCRIPTION

The technology generally relates to identifying service providers that are able and available to perform the work at the time a search query was performed. The identified service providers may be output as part of a list or identified on a map in response to the search query. The identified service providers may be ranked based on one or more factors, including the service provider's availability at the time of the search request, a distance from a business location of the service provider to the location of the work to be performed, a distance from a current location of the service provider to the location of the work to be performed, feedback pertaining to the service provider, etc. Each of the one or more factors may be weighted such that a given factor may influence the rank of the service provider more than another factor. For example, the immediate availability of a service provider may be given more weight than the cost of the services. Based on the weighted score of each factor, each service provider may be given a total score. The service providers with the highest scores may be prioritized in the listing.

According to some examples, service providers may be able to indicate their availability. For example, service providers may be able to log into a service provider portal that is linked with or connected to, their business account with a search service provider. The service provider portal may have a setting that the service provider can change to indicate whether they are available or not. For example, the service provider may be able to toggle a button that switches the indication from “available” to “not available” This may allow the availability of the service provider to be shown in response to a search request.

The service provider may update their availability as they begin or complete service requests. According to one example, the service provider may log in at the beginning of the day to indicate their availability. Later in the day, the service provider responds to a service request. When responding to the service request, the service provider may toggle their availability to “not available.” After completing, or nearing completion of the service request the service provider may toggle their availability to “available.”

In another example, the business may update the status of each service provider. For example, the business may include a dispatcher that can update the status of an employee, agent, associate, etc., of the business. The availability of some or all of the employees may be shown as part of the search results.

At the time of the search request, a distance from the business location of the service provider to the location where work is to be performed may be determined. The business location may be an office, warehouse, etc., associated with the service provider. The business location may be the address associated with the service provider's business profile on the search service provider.

In some examples, a distance from the current location of the service provider to the location where work is to be performed may be determined. For example, the service provider may have completed a service request and changed their availability to “available.” In such an example, the current location of the service provider may be, for example, the location of the previous service request. In another example, the current location of the service provider may be determined based on location data provided from a device being used by the service provider.

Feedback pertaining to the service provider may include, for example, feedback regarding the quality of work, the time it took of the service provider to respond to the service request, the time it took for the service provider to arrive at the location, the time it took for the service provider to perform the work, the cost of the work, etc. The feedback may be provided by a user that either contacted the service provider and/or had work performed by the service provider.

A score for each of the ranking factors may be determined. According to some examples, the search service system may apply a weight to each of the factors such that each factor is given a weighted score. The factor weight may be a value between zero (0) and one (1). However, the factor weight may be any value and, therefore, a value between zero and one is merely exemplary and is not intended to be limiting. Each factor may have a value. The value for each factor may be multiplied by the weight of that factor to determine the score for that factor.

For example, the “availability” factor may be assigned a weight of one (1). If the service provider is available, the value may be (1), whereas if the service provider is not available, the value may be zero (0). The weighted score for availability may be, according to this example, one (1) if the service provider is available and zero (0) if the service provider is not available.

In another example, the feedback factor may be assigned a feedback weight of 0.5. However, the feedback weight can be any value and, therefore, a feedback weight of 0.5 is merely one example and is not intended to be limiting. The value of the feedback may be a numerical value between zero (0) and five (5). However, the feedback value may be any value and, therefore, a range from zero to five is merely one example and is not intended to be limiting. In some examples, the feedback value may correspond to a star rating of the service provider. The assigned feedback weight (i.e., 0.5) may be multiplied by the feedback value (i.e., 0-5) to determine the weighted score.

According to some examples, each piece of feedback may be weighted and/or scored separately. For example, the timeliness to respond to a service request may have a response weight and, therefore, a response score, while the quality of work may have a quality weight and, therefore, a quality score. The weight assigned to each piece of feedback may be different. For example, the timeliness to respond to a service request may be scored higher than the cost of the work performed. In some examples, the timeliness to arrive to perform the work may be scored higher than the time it took to complete the work.

In some examples, the distance factor may be assigned a distance weight. There may be a first distance weight for the distance between the business location of the service provider and the location of work to be done and a second distance weight for the distance between the current location of the service provider and the work to be done. Additionally or alternatively, the first distance weight and the second distance weight may be the same. In other examples, the second distance weight may be greater than the first distance weight or vice versa.

The weighted score for each of the factors may be totaled. Based on the total weighted score for each of the service providers, the service providers may be ranked. According to some examples, a service provider with a higher total weighted score may be ranked higher and, therefore, may appear higher in the search results as compared to a service provider with a lower total weighted score. In some instances, service providers with a lower total weighted score may not be provided in the search results. In this regard, the search results may be limited to a certain number of service providers.

A user may select a service provider from the search results. After selecting the service provider, the user may be prompted to provide feedback regarding the service provider. For example, the user may be asked to rate the service provider's timeliness in responding to the service request. In some examples, the user may be prompted to provide feedback regarding the service provider after the completion of the services. For example, the user may be prompted to provide feedback regarding the service provider's timeliness to arrive for the job, the quality of the work, the cost of the work, the time it took to complete the work, etc. According to some examples, the user may be prompted to provide feedback regarding the service provider when the service provider's location information indicates they left the location of the work. Additionally or alternatively, the user may be prompted to provide feedback when the service provider changes their availability from “unavailable” to “available” after completing the services. The feedback provided by the user may be used to update the feedback factor that is used to rank the service providers.

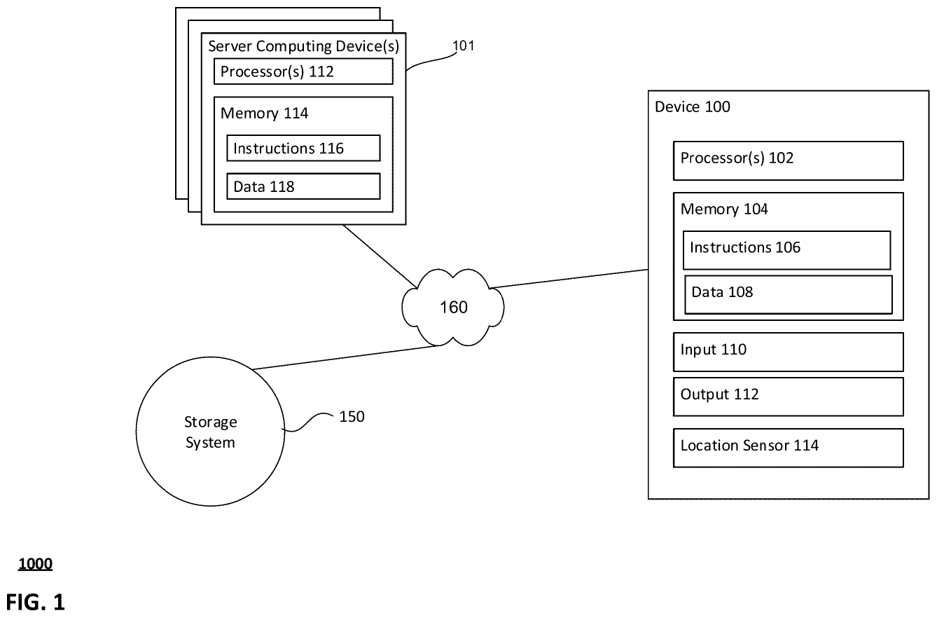

FIG. 1 illustrates an example system in which the features described above and herein may be implanted. It should not be considered as limiting the scope of the disclosure or usefulness of the features described herein. In this example, system 1000 may include a device 100, server computing devices 101, storage system 150, and network 160.

As shown, the device 100 includes various components, such as one or more processors 102, memory 104, and other components typically present in microprocessors, general purpose computers, or the like. Device 100 also includes input 110, microphones 112, and a location determiner such as a global positioning system (“GPS”) sensor 114.

The one or more processors 102 may be any conventional processors, such as commercially available microprocessors. Alternatively, the one or more processors may be a dedicated device such as an application specific integrated circuit (ASIC) or other hardware-based processor. Although FIG. 1 functionally illustrates the processor, memory, and other elements of device 100 as being within the same block, it will be understood by those of ordinary skill in the art that the processor, computing device, or memory may actually include multiple processors, computing devices, or memories that may or may not be stored within the same physical housing. Similarly, the memory may be a hard drive or other storage media located in a housing different from that of device 100. Accordingly, references to a processor or computing device will be understood to include references to a collection of processors or computing devices or memories that may or may not operate in parallel.

Memory 104 may store information that is accessible by the processors 102, including instructions 106 that may be executed by the processors 102, and data 108. The memory 104 may be of a type of memory operative to store information accessible by the processors 102, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 106 and data 108 are stored on different types of media.

Data 108 may be retrieved, stored or modified by processors 102 in accordance with the instructions 106. For instance, although the present disclosure is not limited by a particular data structure, the data 108 may be stored in computer registers, in a relational database as a table having a plurality of different fields and records, XML documents, or flat files. The data 108 may also be formatted in a computer-readable format such as, but not limited to, binary values, ASCII or Unicode. Moreover, the data 108 may comprise information sufficient to identify the relevant information, such as numbers, descriptive text, proprietary codes, pointers, references to data stored in other memories (including other network locations) or information that is used by a function to calculate the relevant data.

The instructions 106 can be any set of instructions to be executed directly, such as machine code, or indirectly, such as scripts, by the processor 102. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods, and routines of the instructions are explained in more detail below.

The device 100 may further include an input 110. The input 110 may be, for example, a touch sensor, dial, button, or other control for receiving a manual command. The input 110 may, in some examples, be a microphone. The device 100 may also include an output 112. The output 112 may be, for example, a speaker.

Device 100 may further include at least one location sensor 114. The location sensors 114 may provide a rough indication as to the location of the device. According to some examples, the location sensors 114 may be GPS sensors.

It should be understood that the device 100 may include other components which are not shown, such as a battery, charging input for the battery, signal processing components, etc. Such components may also be utilized in execution of the instructions 106.

The device 100 may be located at a node of network 160 and capable of directly and indirectly communicating with other nodes of network 160. Although only a single device 100 is depicted in FIG. 1, it should be appreciated that additional devices may be possible. In this regard, a typical system can include a large number of connected computing devices, with each different computing device being at a different node of the network 160.

The network 160 and intervening nodes described herein can be interconnected using various protocols and systems, such that the network can be part of the Internet, World Wide Web, intranets, wide area networks, or local networks. The network can utilize standard communications protocols and systems, such as Ethernet, Wi-Fi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, each server computing device 101 may include one or more servers capable of communicating with storage system 150 as well as device 100 via the network 160. For example, one or more of server computing devices 101 may use network 160 to transmit and present information to a user on a display of devices 101. In this regard, devices 100 may be considered client computing devices and may perform all or some of the features described above and herein.

The server computing devices 101 may be configured similarly to device 100, with one or more processors, memory, and instructions as described above.

Storage system 150 may store data related to service providers for retrieval in response to queries for an available service provider as described herein. As used herein, service providers may include any person or business that can perform specific work or task as requested by a user. The service provider may be associated with a business profile. The business profile of a service provider may be sored on storage system 150. The business profile may include, for example, contact information, availability, ratings, etc. associated with the service provider. According to some examples, the business profile of each service provider may additionally or alternatively be stored on server computing devices 101.

In some examples, storage system 150 may include a database. The database may store information, images, and/or metadata that may be provided by an application, such as a search service provider or a mapping application, in response to a search query or request. Metadata may include any data that may be relevant to one or more service providers or other such data that contains information that may be provided by an application or a map application in response to a query. For example, metadata may include image data, business information, virtual tours of locations, business listing, availability data, ratings, etc.

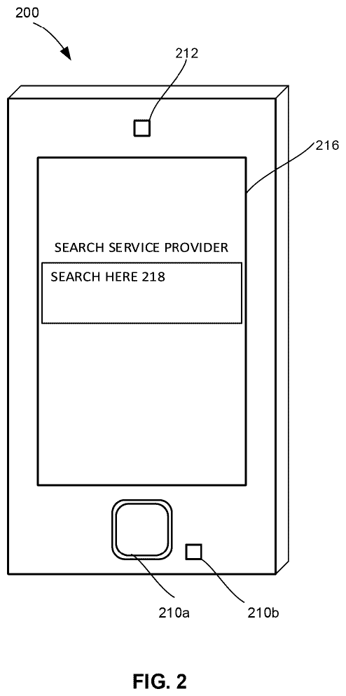

FIG. 2 illustrates an example user interface for performing a search request. Device 200 may include inputs 210a, 210b, such as a touch pad and a microphone, an output 212, such as a speaker, and a display 216. In some examples, the display 216 may be a touch screen capable of receiving user inputs. These features may be similar to those discussed herein with respect to device 100.

Display 216 may output a user interface associated with a mapping service, search service provider, a service provider's website, etc. As shown in FIG. 2, display 216 may output a search service provider's website and/or application. The search service provider's website and/or application may be used to perform a search for an available service provider.

A user may use device 200 to perform a search for an available service provider. For example, the user may open an application or website of a search service provider and input search terms into a “search here” text box 218. The search terms may be text, images, videos, etc., that describe or identify a service to be performed and/or a type of service provider. According to some examples, a user may use a touch screen, such as display 216, to input a search request into device 100. Additionally or alternatively, a user may use voice commands to input a search request. Service providers may include, for example, electricians, plumbers, locksmiths, dog walkers, pet sitters, medical professionals, mechanics, carpenters, handymen, lawyers, notaries, house cleaners, etc. While numerous examples of service providers are provided, the list is not exhaustive and, therefore, is not intended to be limiting.

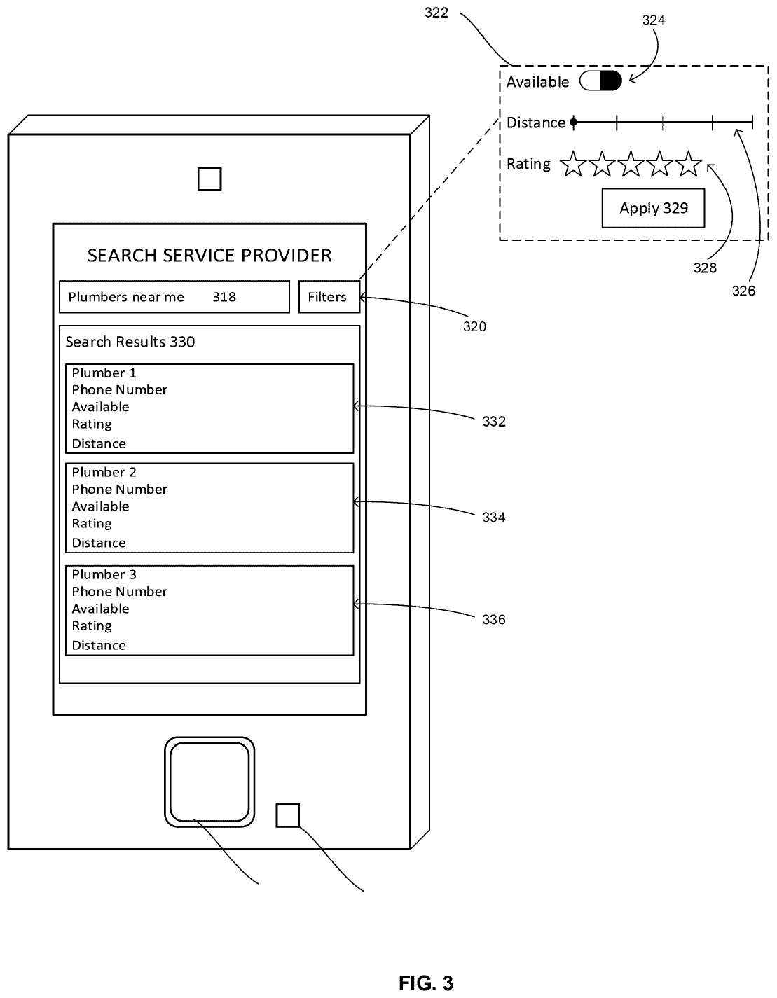

FIG. 3 illustrates an example user interface showing search results. The search results 330 may be displayed as a list of service providers. The service providers provided in response to the search query may match one or more search criteria entered in the search text box 318. For example, if “plumbers near me” was input into the search text box 318, the search results 330 may include a list of plumbers 332, 334, 336 near the location the search was performed. The location of the search may be determined based on location data provided from the device 200 being used to perform the search. For example, the location sensor 114 of device 200 may provide location data to the search service provider. The location data may identify the location of the device 200 and, therefore, the location where the search is being performed. In another example, the search query may include a location provided by the user. For example, a user may provide a location where services are being requested, such as a zip code, address, geolocation (e.g., latitude/longitude coordinates), etc. The search will then return results based on the provided location provided by the user.

As shown in FIG. 3, the search results may be shown as a list. The list may include an information card for each of the service providers. The list may be organized based on the ranking of each service provider. For example, the highest ranking service provider may be the first service provider shown on the list and the lowest ranking service provider may be the last on the list. Provide some other examples, such as cards or even just a single result.

The service providers may be ranked by server computing devices 110 based on one or more factors. The factors may include, for example, the service providers availability at the time of the search request, the distance from the business location of the service provider to the location of the work to be done, the distance from a current location of the service provider to the location of work to be performed, feedback pertaining to the service provider, the cost of the services, etc. Each of factors may be weighted and/or scored using a factor weight. According to some examples, each of the factors may be given a weighted score. The weighted score for each of the factors may be totaled to provide a service provider score. In some examples service providers with the highest score may be ranked highest in the search results.

The availability of a service provider may be determined based on information provided by the service provider. According to some examples, the server computing devices 110 may determine the available of the service provider. For example, the server computing devices 110 may determine that the service provider is going to be available in the near future based on when the server provider last changed their availability status to “unavailable” and the average length of time it takes to complete a service. The likeliness to become available in the near future may be considered when ranking the service providers.

The availability factor may be assigned a weight. For example, if the service provider is available, the availability factor may be assigned a predetermined weight. According to some examples, the weight for an available service provider may be one (1) whereas the weight for a service provider that is not available may be zero (0). Additionally or alternatively, the weight for a service provider that is likely to become available in the near future may be 0.5. The weight that is assigned for a service provider that is likely to become available in the near future may depend on how soon the service provider is likely to become available. For example, an availability weight of 0.75 may be applied to a service provider that is likely to become available in the next fifteen (15) minutes whereas an availability weight of 0.25 may be applied to a service provider that is likely to become available in the next hour. In some examples, instead of a weight, the availability factor may be assigned a score of 1, 0.5, or 0, indicating available, likely to become available, or not available, respectively.

The distance from the business location of the service provider to the location of work to be completed may be determined based on information interested by the service provider and/or the user. For example, the address associated with the service provider may be part of the service provider's business profile. In some examples, the business location may be the address that appears when a search is performed for the specific service provider.

The service provider's business profile may be stored on the server computing devices 101 and/or storage system 150. The business profile may include, for example, the service provider's contact information including their business name, address, phone number, website, e-mail address, phone number, fax number, etc. The business profile may additionally or alternatively include an indication of the service provider's availability. The ratings associated with the service profile may also be accessible via the service provider's business profile. A service provider may log into a service provider portal associated with the search service profile to update the information associated with the business profile.

The distance from the current location of the service provider to the location of the work to be completed may be determined based on location signals. For example, the current location of the service provider may be determined based on location data provided from a device being used by the service provider.

The location of work to be completed may be the current location of the user. Additionally or alternatively, the location of work to be performed may be entered by the user. The search service provider may use this information to determine the distance between the business location and the work location and/or the distance between the current location of the service provider and the work location. According to some examples, the distance between the current location of a service provider and the work location may be less than the distance between the business location of that service provider and the work location. In such an example, the search service provider may use the shortest distance when determining a distance score. Additionally or alternatively, the search service provider may user the longer distance and/or both distances when determining a distance score.

The distance score may be determined using a distance weight. In some examples, there may be a first distance weight for the distance between the business location and work location and a second distance weight for the distance between the current location and work location. Additionally or alternatively, the first distance weight and the second distance weight may be the same. In some examples, the first distance weight may be greater than the second distance weight or vice versa. For example, a service provide whose current location is closer to the work location may be weighted more than a business location of that same service provider that is further from the work location. The weighted distance score may be determined bac

The feedback factor may be assigned a feedback weight. The feedback factor may have a feedback value corresponding a rating shown for the service provider. The rating may be based on feedback from the user pertaining to various aspects of their interaction with the service provider. For example, the rating may be based on how quickly the service provider responded to the user's inquiry for services, how quickly the service provided arrived to perform the services, the quality of the services, the time it took the service provider to complete the services, the cost of the services, etc. A user's answers to each of these questions may be used to determine the service provider's rating. The rating may be on a scale of zero to five, with zero being terrible and five being the best. The feedback value may correspond to the rating value between zero and five. The weighted feedback score may be determined by multiplying the feedback weight by the feedback value.

The weighted score for each of the factors may be totaled. The service providers may be ranked based on the total weighted score for each of the services providers. According to some examples, a service provider with a higher total weighted score may be ranked higher and, therefore, may appear higher in the search results as compared to a service provider with a lower total weighted score. In some instances, service providers with a lower total weighted score may not be provided in the search results. In this regard, the search results may be limited to a certain number of service providers.

The search results may be output as a list. The list may include an information card for each of identified service providers. The information card may include information pertaining to that service provider. As shown, the information cards for each plumber includes the best mode of contacting the service provider, such as a phone number, an indication of their availability, their rating, and a distance. In some examples, the availability of the service provider may be shown by stating “available” or “not available.” Additionally or alternatively, the availability of the service provider may be shown using a color coded indication. For example, there may be a green indication to represent that the service provider is available and a red indication to represent that the service provider is not available. The rating of the service provider may be based on a scale determined by the search service provider. For example, the scale may be a number value between zero (0) and five (5), with five being better than one. The scale may be, however, any range set by the search service provider. The rating may be based on feedback from user that have worked with the service provided previously. The distance may be a distance from the service provider's business location to the location of the work to be done. For example, the distance may be from the office or warehouse of the plumber to the user's home. In some examples, the distance may be a distance from the current location of the service provider to the location of the work to be done. For example, the service provider may be having lunch at a local restaurant. In such an example, the distance would be the distance from the local restaurant to the location of the work to be done.

According to some examples, the search results 330 may be filtered using one or more filters 320. For example, the user interface may include a “filters” 320 option. In response to “filters” 320 being selected, a pop-up screen 322 may appear. Pop-up screen 322 may appear as a new screen. Additionally or alternatively, pop-up screen 322 may appear as an overlay to the search screen and/or search results 330. The pop-up screen 322 may include one or more filters, or additional search criteria, that can be used to filter the search results 330. For example, the filters 320 may include whether the service provider is currently available, the distance from the service provider to the location of the work, the rating of the service provider, etc.

To filter the search result based on availability of the service provider, a user may toggle 324 between the service providers being available or not. In some examples, the default settings may be to provide results that show only available service providers. While a toggle 324 is used to filter the search results to show only service providers that are available or to show all service providers, some user interfaces may include buttons that can be selected by the user. The buttons may include an option for “available” and another for “show all.” In some examples, there may be a drop down menu providing options for the user to select. Additionally or alternatively, there may be check boxes that may allow the user to select more than one option regarding the availability of the service provider. Therefore, while a toggle 324 is shown, a toggle 324 is merely one option for filtering the availability of a service provider and is not intended to be limiting.

The user may select a search radius for the service provider to be located in. In some examples, the user may move an indicator along a slider 326 to select the maximum search radius from the location of where the work is to be performed. For example, the user may filter the search results 330 to include only service providers located within 15 miles from the location of the work to be done. In some examples, the search service provider, in response to the search request and the distance filter, may determine the distance from the current location of a service provider to the work location and the distance from the business location to the work location. If one or both of those distances fall within the distance selected by the user, the service provider may be listed in the search results. While the search radius is shown as a slider 326, the distance may be input into a text box, may be selected from a drop down, may be marked on a map by drawing a search radius, etc. Therefore, showing the distance filter as a slider 326 is merely one example and is not intended to be limiting.

The search results 330 may be filtered based on the rating of the service providers. For example, the pop up screen 322 may include an option for the user to select a star rating 328. The user may select a minimum rating, or number of stars, for the service provider to appear in the search results 330. For example, a user may select fours tars as the minimum rating. While the rating filter is shown by stars 328, the rating filter may selected from a drop down menu, buttons, check boxes, text input, slider, etc. Therefore, showing the rating filter as stars 328 is merely one example and is not intended to be limiting.

Any number of filters may be selected and/or applied to the search results. According to some examples, the user may not apply any filters. In such an example, the search results may use default search filters. In some examples, filters may be selected before a search results is submitted. After a user selects the filters to be applied to the search results 330, the user may select apply 329. Once apply 329 is selected, the pop-up screen 322 may close and the search results 330 may be updated with the applied filters.

FIG. 4 illustrates an example user interface for performing a search request. Device 400 may include inputs 410a, 410b, such as a touch pad and a microphone, an output 412, such as a speaker, and a display 416. In some examples, the display 416 may be a touch screen capable of receiving user inputs. These features may be similar to those discussed herein with respect to device 100.

A search for an available service provider may be performed using device 400. For example, the user may open a map application to search for an available service provider. The map application may indicate the current location 442 of the user on map 440. In some examples, the current location 442 of the user may be based on location data provided by the device being used by the user. According to some examples, when the location of the work to be done is not the same as the current location 442 of the user, the user may be able to place a marker 443 on map 440 indicating the location of the work to be done. Additionally or alternatively, a user may provide a location where services are being requested, such as a zip code, address, geolocation (e.g., latitude/longitude coordinates), etc.

The user may input search terms into a “search here” text box 418. The search terms may be text, images, videos, etc., that describe or identify a service to be performed and/or a type of service provider.

According to some examples, prior and/or subsequent to submitting the search, the user may select one or more filters. When selecting filters 420, a pop-up screen 422 may appear with a number of filters. As shown, filters 420 may include whether the service provider is available, the distance from the service provider to the location of the work to be performed, the rating of the service provider, etc. In some examples, the distance may be the distance from the current location of the service provider to the work location and/or the distance from the business location of the service provider to the work location. By selecting one or more filters, the user may be able to find the most relevant service providers in response to their search. As explained above in conjunction with respect to FIG. 3, the filters shown and the selection modalities are merely examples and are not intended to be limiting.

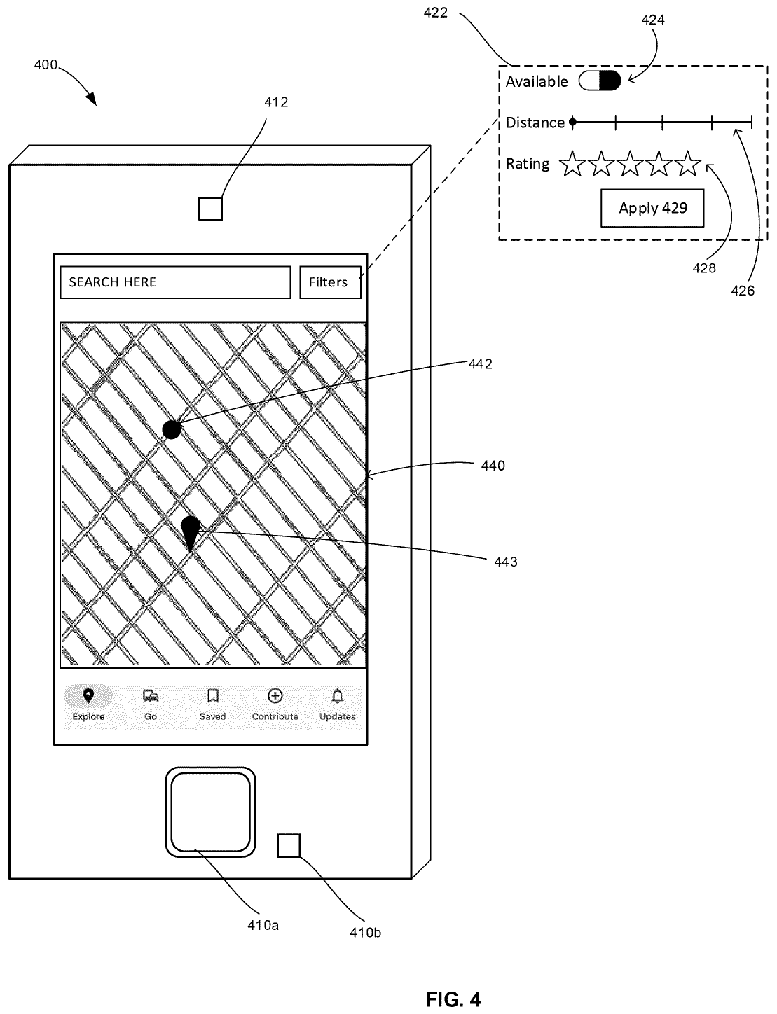

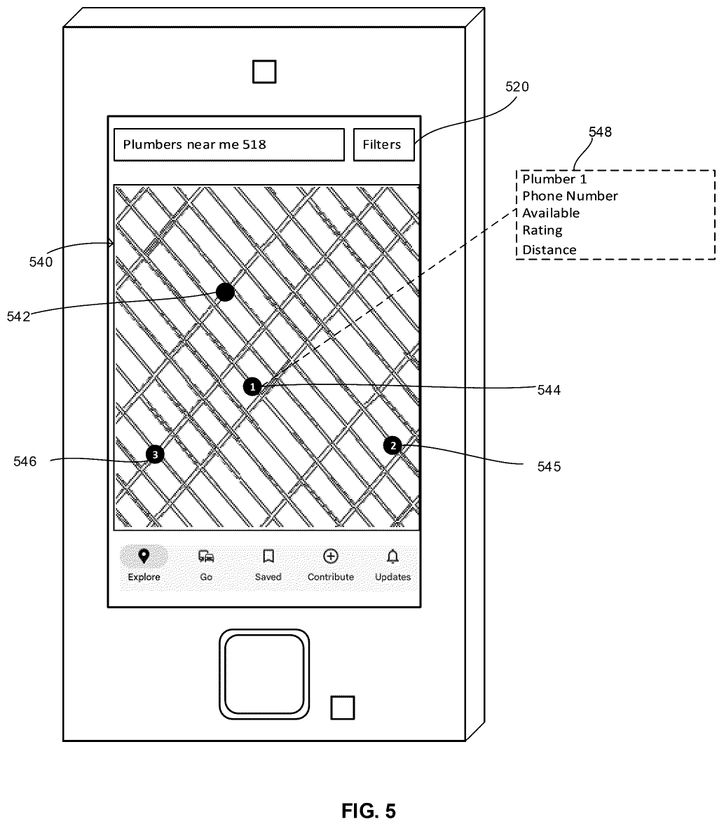

FIG. 5 illustrates an example user interface showing search results. The search results may be shown as markers 544, 545, 546 on map 540. In some examples, the markers 544, 545, 546 may be shown with a number indicating their rank. The service providers may be ranked as discussed above in conjunction with FIG. 3. For example, marker 546 may include the number one (1) to indicate that that service provider is ranked highest in the search results, whereas marker 548 may include the number three (3) to indicate that that service provider was the third highest ranked service provider.

When one of markers 544, 545, 546 is selected, a pop-up screen may appear. For example, when marker 544 is selected, pop-up screen 548 may appear as an overlay on map 540. The pop-up screen 548 may be an information card. The information card may include information pertaining to the service provider associated with marker 544. The information may include, for example, contact information, such as a phone number, an indication regarding the availability of the user, the distance from the service provider to the work location, the rating of the user. In some examples, the information may additionally or alternatively include the service provider's hours of operation, address, website, e-mail address, etc.

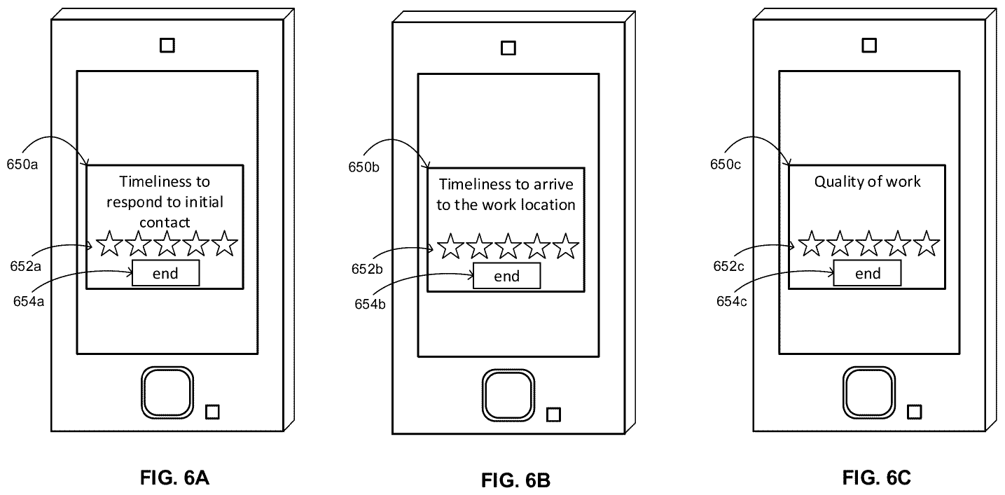

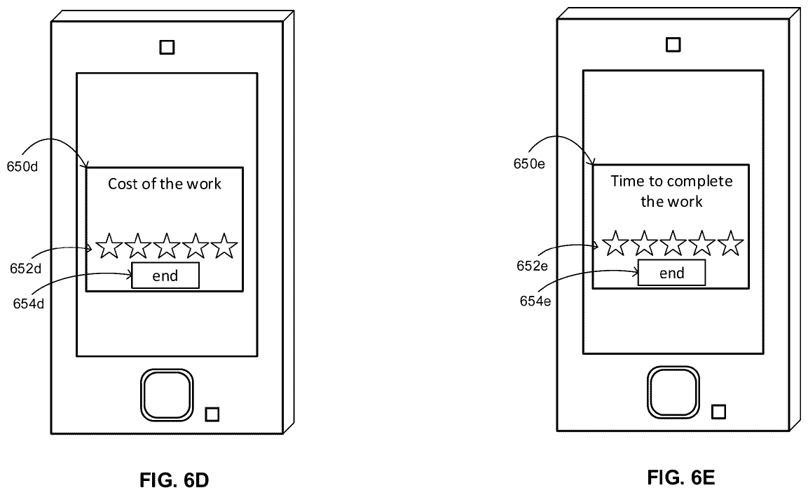

FIGS. 6A-6E illustrate example user interfaces for providing feedback regarding the service provider. According to some examples, the user may be prompted to provide feedback regarding the service provider after initially contacting the service provider, while the work is being performed, and/or after the service provider completes the work. According to some examples, the completion of the work may be determined based on the service provider changing their availability from “not available” to “available” in the service provider portal. Additionally or alternatively, the completion of the work may be determined based on location data from a device being used by the service provider indicating the service provider is no longer at the work location. In some examples, there may be an option to “end” the feedback prompts. The user may select end if the user does not want to answer any feedback questions.

In some examples, after the user selects and/or contacts a service provider from the search results, prompt 650a may be presented to the user to provide feedback regarding the service provider's timeliness in responding to the initial contact from the user. Additionally or alternatively, prompt 650a may be presented to the user after the service provider completes the work. For example, the user may call a service provider from the list of search results but the service provider may not pick up the call. Instead, the user may have had to leave a message for the service provider. According to some examples, the user may rate the service provider based on how quickly the service provider returns their message.

As shown in FIG. 6A, the user may rate the service provider by selecting a number of stars 652a. In some examples, five stars may indicate that the service provider responded to the user's initial contact quickly, whereas zero starts may indicate that the service provider never answered the user. In some examples, the user may be prompted to provide feedback regarding the service provider's timeliness in responding to the initial contact after the service provider has completed the service.

Additionally or alternatively, the prompt 650a may include an option to “end” 654a. The user may select end 654a if the user does not want to provide any feedback. If the user selects end 654a, no further prompts will be displayed.

According to some examples, prompt 650b may be presented to the user to provide feedback regarding the service provider's timeliness to arrive for the job. The timeliness to arrive for the job may be the time it takes for the service provider to arrive to the work location after agreeing to perform the work. As shown in FIG. 6B, the user may rate the service provider's timeliness to arrive by selecting a number of stars 652b. In some examples, the greater the number of stars 652b selected, the more satisfied the user may be with how long it took the service provider to arrive for the job. Additionally or alternatively, the fewer stars 652b selected, the less satisfied the user may be with how long it took the service provider to arrive for the job. In some examples, the ratings may reversed such that a lower number of stars 652b indicates a greater satisfaction as compared to a higher number of stars 652b.

As shown in FIG. 6C, prompt 650c may be presented to the user to provide feedback regarding the quality of work completed by the service provider. The quality of work may include, for example, how well the service provider completed the job, whether the service provider cleans up after themselves, whether the user is satisfied with the completed work, etc. As shown in FIG. 6C, the user may rate the quality of work completed by the service provider by selecting a number of stars 652c. In some examples, the greater the number of stars 652c selected, the more satisfied the user may be with the quality of work completed by the service provider. Additionally or alternatively, the fewer stars 652c selected, the less satisfied the user may be with the quality of work. In some examples, the ratings may be reversed such that a lower number of stars 652c indicates a greater satisfaction as compared to a higher number of stars 652c.

FIG. 6D illustrates another prompt 650d that may be presented to the user to provide feedback regarding the cost of work completed by the service provider. As shown in FIG. 6D, the user may rate the cost of the work performed by the service provider by selecting a number of stars 652d. In some examples, the greater the number of stars 652d selected, the more satisfied the user may be with the cost of work completed by the service provider. Additionally or alternatively, the fewer stars 652d selected, the less satisfied the user may be with the cost of work. In some examples, the ratings may reversed such that a lower number of stars 652d indicates a greater satisfaction as compared to a higher number of stars 652d.

FIG. 6E illustrates another prompt 650e that may be presented to the user to provide feedback regarding the length of time it took the service provider to complete the work. In some examples, the length of time it took to complete the work may be the time it took the service provider to complete the work after arriving at the work location. Additionally or alternatively, the time it took to complete the work may be the time period starting with the initial contact until the service provider completes the service.

As shown in FIG. 6E, the user may rate the length of time it took the service provider to complete the work by selecting a number of stars 652e. In some examples, the greater the number of stars 652e selected, the more satisfied the user may be with the length of time it took to complete the work. Additionally or alternatively, the fewer stars 652e selected, the less satisfied the user may be with the length of time. In some examples, the ratings may be reversed such that a lower number of stars 652c indicates greater satisfaction as compared to a higher number of stars 652e.

While the rating for each prompt is shown as stars 652a-e, the selection may be a drop down menu with numerical value and/or words, check boxes and/or buttons with corresponding numerical values and/or words, a text box for the user to manually enter a rating, etc. Therefore, stars are merely one example and are not intended to be limiting. Additionally or alternatively, each prompt may include a text box for additional comments to be provided by the user. The additional comments may be an explanation for the rating. In some examples, the comments may be presented alongside the rating of the service provider in the search results.

Additionally or alternatively, prompts 650a-e may include an option to “end” 654a-e. The user may select end 654a-e if the user does not want to provide any feedback. If the user selects end 654a-e, no further prompts will be displayed. The user may select end 654a-e after the first, second, third, etc., prompt allowing the user to provide as much or as little feedback as they want.

The feedback provided by the user may be used to update the feedback factor that is used to rank the service providers. For example, the rating from each of the feedback prompts may be weighted individually. In some examples, the ratings from each of the feedback prompts may be totaled to determine a feedback value. For example, the feedback value may be used to rank the service provider without applying a weight. Additionally or alternatively, the feedback value may be weighted to determine a weighted feedback score.

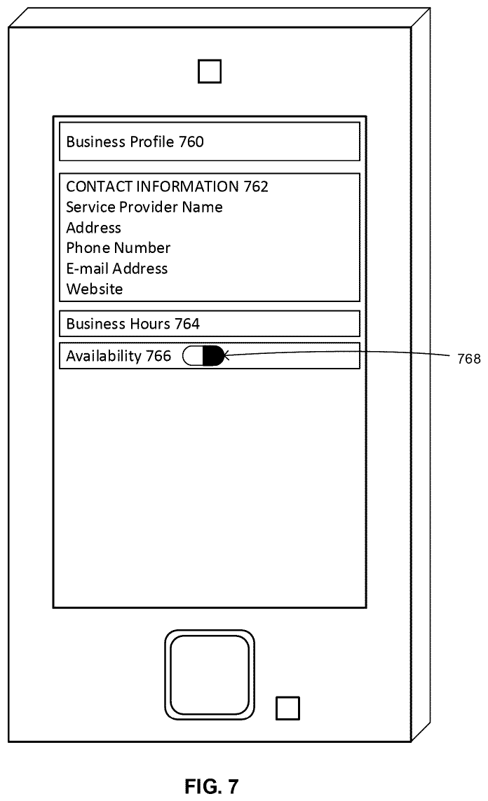

FIG. 7 illustrates an example user interface for a service provider to update information pertaining to their business profile as well as their availability. For example, a service provider may use device 700 to access their business profile 760 associated with a search service provider. Additionally or alternatively, the service provider may sign into a service provider portal that is linked with or connected to their business account with a search service profile. The business profile 760 may include contact information 762, business hours 764, availability 766, etc. In some examples, the business profile 760 may allow the service provider to upload pictures, videos, multimedia, etc., related to the services they provide.

In some examples, the service provider may access their business profile 760 to change their availability. As shown, the service provider may toggle 768 between available and not available. While a toggle 768 is shown to indicate whether the service provider is available or not, some user interfaces may include buttons that can be selected by the service provider. The buttons may include an option for “available” and another for “not available.” In some examples, there may be a drop down menu providing options for the service provider to select. Additionally or alternatively, there may be check boxes that may allow service provider to select certain times during the day that they will be available, etc. Therefore, while a toggle 768 is shown, a toggle 768 is merely one option for the service provider to indicate whether they are available or not.

According to some examples, the availability 766 section of the business profile may include a list of individual employees, agents, associates, etc., of the business. In such an example, the availability of each individual service provider may be updated in the business profile 760. In some examples, the availability of the individual employees, agents, associates, etc., of the business may be updated by a dispatcher associated with the business.

### Example Use Case

According to one example, a user may search for plumbers to perform work at their home. The user may submit a search request for “plumbers near me” via a search service provider. In response to the search request, one or more plumbers near the location of the user may be identified. According to some examples, the user may select and/or apply one or more filters prior or subsequent to submitting the search request. In some examples, the user the search results may be filtered by a search radius. For example, the user may identify a search radius with the center of the radius being the work location. Additionally, or alternatively, the system performing the search may have a predefined search radius. In some examples, the user may filter the search such that only service providers that are available at the time of the search request are included in the search results.

The plumbers identified in response to the search request may be ranked. For example, the plumbers may be ranked based on one or more factors. The factors may include whether the plumber is available to perform work at the time of the search request, a distance from the plumber's business location to the home of the user, a distance from the current location of the plumber to the home of the user, feedback of the plumber's past service requests, etc. A plumber that is available to perform work at the time of the search request may rank higher than a plumber that is unavailable. In some examples, a plumber whose current location is a closer distance to the user's home may rank higher than a plumber whose business location is further from the user's home. According to some examples, a plumber with a higher feedback rating may rank higher than a plumber with a lower feedback rating.

After selecting and/or contacting a plumber, the user may be prompted to provide feedback. In some examples, the user may be asked how long it took for the plumber to respond after the user contacted the plumber. Additionally, or alternatively, the user may be asked how long it took for the plumber to arrive after contacting the plumber. In other examples, the user may be asked to rate the quality of work, cost of the work, timeliness of completion, etc. The feedback provided by the user may be used to update the feedback factor. According to some examples, as the feedback factor is updated, the overall total weighted score for the plumber may be updated.

### Example Methods

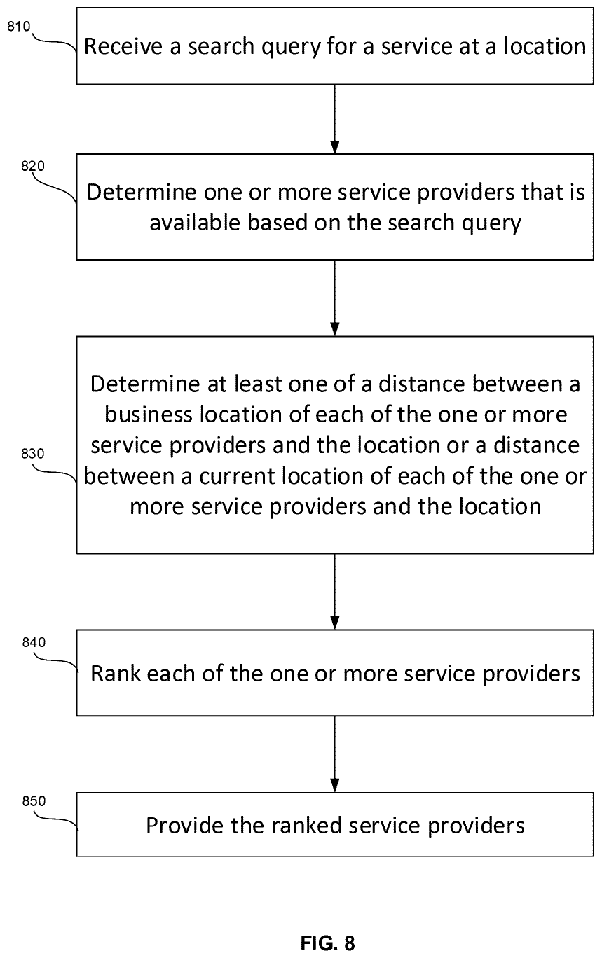

FIG. 8 illustrates an example method for identifying service providers that are available and able to perform the work at the time a search query was performed. The following operations do not have to be performed in the precise order described below. Rather, various operations can be handled in a different order or simultaneously, and operations may be added or omitted.

In block 810, a search query for a service at a location may be received. The search query may include one or more terms, audio content, visual media, etc., related to the type of service and/or work to be completed. In some examples, the search query may include text identifying the type of service provider, an indication of the location where the work is to be performed, etc. For example, if a user is locked out of their house, the user may use their device to search for a “locksmith near me.” The search service provider may determine the location based on location data received from the user's device.

In block 820, one or more service providers that are available based on the search query may be determined. The availability of a service provider may be determined based on the service provider's indicted availability in their business profile. A service provider's business profile may be associated with the search service provider. Determining the one or more service providers that are available may further include identifying one or more service providers within a search radius. The search radius may be a predetermined distance from the work location. In some examples, the search radius may be set by a user. For example, the user may set the search radius to be a maximum distance away from the work location.

In block 830, at least one of a distance between a business location of each of the one or more service providers and the location or a distance between a current location of each of the one or more service providers and the location may be determined based on the identified one or more available service providers. For example, the business location may be the address listed in the service provider's business profile. The current location of the service provider may be determined based on location data provided from a device being used by the service provider.

In block 840, each of the one or more service providers may be ranked. The ranking of each of the service providers may be based on user feedback. The user feedback may include a rating of one or more of quality of work, timeliness to respond to a user request, cost of work, length of time to arrive, and preparedness to complete a job.

In block 850, the ranked service providers may be provided for output. For example, the ranked service providers may be provided as a list of the ranked service providers in ranked order or a map indicating a location and a rank of each ranked service provider.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “ ” “such as” “,” “““including””” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving, by one or more processors, a search query for a service at a service location;
determining, by the one or more processors and based on the search query, one or more service providers and respective availabilities for the one or more service providers;
determining, by the one or more processors and based on the determined one or more service providers, at least one of (i) a distance between a business location of each of the one or more service providers and the service location or (ii) a distance between a current location of each of the one or more service providers and the service location;
ranking, by the one or more processors based on the availabilities of the one or more service providers and at least one of the determined distances, each of the one or more service providers; and
providing, by the one or more processors, the ranked service providers.

2. The method of claim 1, wherein determining the one or more service providers based on the search query further includes identifying, by the one or more processors, the one or more service providers within a search radius.

3. The method of claim 2, wherein the search radius is a predetermined distance from the service location.

4. The method of claim 1, wherein ranking each of the one or more service providers is further based on user feedback.

5. The method of claim 4, wherein the user feedback includes a rating of one or more of quality of work, timeliness to respond to a user request, cost of work, length of time to arrive, and preparedness to complete a job.

6. The method of claim 1, further comprising receiving, by the one or more processors, an indication of availability from each of the one or more service providers, wherein the indication of availability indicates that a respective service provider is currently available or unavailable.

7. The method of claim 6, wherein the determining the respective availabilities for the one or more service providers is based on the indications of availability received from the service providers.

8. The method of claim 1, wherein providing the ranked service providers further includes providing a list of the ranked service providers in ranked order or a map indicating a location and a rank of each ranked service provider.

9. The method of claim 1, wherein the respective availabilities each comprise an availability score indicating a likelihood of a respective service provider being available to perform the service.

10. The method of claim 1, further comprising determining a distance score based on the at least one of (i) the distance between a business location of each of the one or more service providers and the service location or (ii) the distance between a current location of each of the one or more service providers and the service location, wherein the ranking each of the one or more service providers is based on the distance score.

11. The method of claim 10, wherein the distance score is based on whichever is shorter out one of (i) the distance between a business location of each of the one or more service providers and the service location or (ii) the distance between a current location of each of the one or more service providers and the service location.

12. A device, comprising:
a memory; and
one or more processors in communication with the memory, the one or more processors configured to:
receive a search query for a service at a service location;
determine, based on the search query, one or more service providers and respective availabilities for the one or more search providers;
determine, based on the determined one or more service providers, at least one of (i) a distance between a business location of each of the one or more service providers and the service location or (ii) a distance between a current location of each of the one or more service providers and the service location;
rank, based on the availabilities of the one or more service providers and at least one of the determined distances, each of the one or more service providers; and
provide the ranked service providers.

13. The device of claim 12, wherein when determining the one or more service providers based on the search query the one or more processors are further configured to identify the one or more service providers within a search radius.

14. The device of claim 13, wherein the search radius is a predetermined distance from the service location.

15. The device of claim 12, wherein ranking each of the one or more service providers is further based on user feedback.

16. The device of claim 15, wherein the user feedback includes a rating of one or more of quality of work, timeliness to respond to a user request, cost of work, length of time to arrive, and preparedness to complete a job.

17. The device of claim 12, wherein the one or more processors are further configured to receive an indication of availability from each of the one or more service providers, wherein the indication of availability indicates that a respective service provider is currently available or unavailable.

18. The device of claim 12, wherein the determining the respective availabilities for the one or more service providers is based on the indications of availability received from the service providers.

19. The device of claim 12, wherein providing the ranked service providers further includes providing a list of the ranked service providers in ranked order or a map indicating a location and a rank of each ranked service provider.

20. The device of claim 12, wherein the respective availabilities each comprise an availability score indicating a likelihood of a respective service provider being available to perform the service.

21. The device of claim 1, wherein the one or more processors are further configured to determine a distance score based on the at least one of (i) the distance between a business location of each of the one or more service providers and the service location or (ii) the distance between a current location of each of the one or more service providers and the service location, wherein the ranking each of the one or more service providers is based on the distance score.

22. The device of claim 21, wherein the distance score is based on whichever is shorter out one of (i) the distance between a business location of each of the one or more service providers and the service location or (ii) the distance between a current location of each of the one or more service providers and the service location.

23. A non-transitory computer-readable medium storing instructions, which when executed by one or more processors, cause the one or more processors to:
receive a search query for a service at a service location;
determine, based on the search query, one or more service providers and respective availabilities for the one or more search providers;
determine, based on the determined one or more service providers, at least one of (i) a distance between a business location of each of the one or more service providers and the service location or (ii) a distance between a current location of each of the one or more service providers and the service location;
rank, based on the availabilities of the one or more service providers and at least one of the determined distances, each of the one or more service providers; and
provide the ranked service providers.

24. The non-transitory computer-readable medium of claim 23, wherein when determining the one or more service providers based on the search query the one or more processors are further configured to identify the one or more service providers within a search radius.

25. The non-transitory computer-readable medium of claim 24, wherein the search radius is a predetermined distance from the service location.

26. The non-transitory computer-readable medium of claim 23, wherein ranking each of the one or more service providers is further based on user feedback.

27. The non-transitory computer-readable medium of claim 26, wherein the user feedback includes a rating of one or more of quality of work, timeliness to respond to a user request, cost of work, length of time to arrive, and preparedness to complete a job.

28. The non-transitory computer-readable medium of claim 23, wherein the one or more processors are further configured to receive an indication of availability from each of the one or more service providers, wherein the indication of availability indicates that a respective service provider is currently available or unavailable.

29. The device of claim 23, wherein the determining the respective availabilities for the one or more service providers is based on the indications of availability received from the service providers.

30. The non-transitory computer-readable medium of claim 23, wherein providing the ranked service providers further includes providing a list of the ranked service providers in ranked order or a map indicating a location and a rank of each ranked service provider.

31. The non-transitory computer-readable medium of claim 23, wherein the respective availabilities each comprise an availability score indicating a likelihood of a respective service provider being available to perform the service.

32. The non-transitory computer-readable medium of claim 23, wherein the one or more processors are further configured to determine a distance score based on the at least one of (i) the distance between a business location of each of the one or more service providers and the service location or (ii) the distance between a current location of each of the one or more service providers and the service location, wherein the ranking each of the one or more service providers is based on the distance score.

33. The non-transitory computer-readable medium of claim 32, wherein the distance score is based on whichever is shorter out one of (i) the distance between a business location of each of the one or more service providers and the service location or (ii) the distance between a current location of each of the one or more service providers and the service location.
